(19) United States
(12) Patent Application Publication
(10) Pub. No.: US 2004/0078655 A1
(43) Pub. Date: Apr. 22, 2004

(54) Apparatus and method for power integrated control

(76) Inventor: Si-Wook Sung, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/240,244

(22) PCT Filed: Mar. 30, 2001
(86) PCT No.: PCT/KR01/00530

(30) Foreign Application Priority Data
Mar. 30, 2000 (KR) 2000/16477

(51) Int. Cl. G06F 11/00

(52) U.S. Cl. 714/14

(57) ABSTRACT

A built-in type power integrated controller which stably supplies electrical power to a computer system and protects the system from various power failures which may occur in a power supply and a method therefor are provided. The power integrated controller includes a power generator that drops DC voltage generated by a first rectifier in the event of a normal power supply and by a battery in the event of a power outage to DC voltage levels that are supplied to each component of the system and inverts the DC power to AC power. Thus, the size of an inverter decreases so that it is easier to incorporate the inverter into the system. The built-in battery is employed to automatically shut down and boot the system in a case where there is a power failure while a user is away from the system. Furthermore, a power failure status is sent to a system manager and a user working at a remote location through a wired or wireless network thereby enabling them to appropriately cope with the power failure.

### TECHNICAL FIELD

The present invention relates to an apparatus and method for power integrated control, and more particularly, to a power integrated controller which is built into a computer system to stably supply electrical power from a power source and protect the system from various power failures which may occur in the power source, and a method therefor.

### BACKGROUND ART

Generally, data loss, system errors, and program malfunction in computer systems are mainly caused by instability of a power source or power failures. Power failures common in most computer systems include sags, which are a temporary reduction in a voltage value, a blackout condition in which the electricity supply stops, spikes, which are a dramatic surge in voltage value, and surges, which are over-voltage excursions. In the event of an unexpected power outage caused by such power failures, work files cannot be completely saved nor can programs be terminated stably, thereby causing data loss and problems in the operation of a system. To overcome this, an uninterruptible power supply (UPS) has been developed. However, the UPS has problems in that the manufacturing cost is high since the UPS is externally provided and its size is large. Furthermore, DC power rectified in a rectifier is inverted to AC power which a system uses, thereby increasing the size of an inverter. In addition, a system monitor which monitors power status and directly reports a detected power failure to the outside must always be located within the system.

### DISCLOSURE OF THE INVENTION

To solve the above problems, it is an object of the present invention to provide a built-in type power integrated controller which stably supplies electrical power to a computer system and protects the system from various power failures by automatically shutting down and booting the system and notifying a user of the power failure situation, and a method therefor.

To accomplish the above objects, the present invention provides a power integrated controller which includes: a power sensor that senses the status of AC power input from the outside of the power integrated controller and generates a power supply and a power failure signal; a first rectifier that converts the AC power received through the power sensor to DC power when a power switch is on; a second rectifier that converts the AC power from the outside into DC power; a battery that is charged with the DC power converted by the second rectifier in the event of normal power supply and discharges the charged DC power in the event of a power failure; a power generator that drops the DC power generated by the first rectifier in the event of normal power supply and by the battery in the event of a power failure to DC voltage levels which are supplied to each component of a system, and inverts the DC power to AC power; and a power operator that, upon receiving a power failure signal from the power sensor, sends information about power failure conditions and battery back-up time to a predetermined terminal through a communication network to save work data and issue a shut down command, and upon receiving a power recovery from the power sensor, boots the system and sends a booting message to the terminal through a communication network.

The present invention also provides a power integrated control method which includes the steps of: charging a battery and operating a system normally upon supplying power to the system; operating the battery and sending information about a power failure status and battery back-up time to a system manager and a predetermined terminal through a communication network to save work data and shut down the system, upon receiving a power failure signal from a power sensor during normal operation; and booting and logging into the system and sending a booting message to the predetermined terminal through a communication network upon receiving a power recovery signal from the power sensor.

### BRIEF DESCRIPTION OF THE DRAWINGS

FIG. 1 is a block diagram of a power integrated controller according to the present invention; and

FIG. 2 is a flowchart showing a power integrated control method according to the present invention.

### BEST MODE FOR CARRYING OUT THE INVENTION

The present invention will now be described more fully with reference to the accompanying drawings, in which preferred embodiments of the invention are shown.

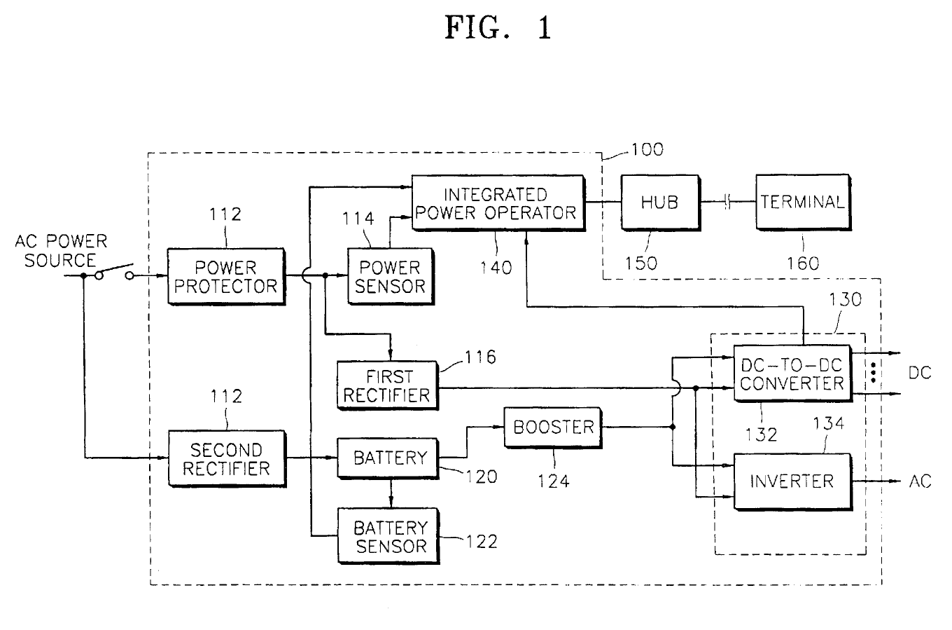

Referring to FIG. 1, a power integrated controller 100 which receives AC power includes a power protector 112, a power sensor 114, a first rectifier 116, a battery 120, a battery sensor 122, a second rectifier 126, a booster 124, a power generator 130, and an integrated power operator 140 and is installed into a system. The power integrated controller 100 is connected to each client terminal 160 through a hub 150 using a wired or wireless network. Furthermore, the power generator 130 includes a DC-to-DC converter 132 and an inverter 134, which output DC and AC power, respectively.

When electrical power is normally supplied, the first rectifier 116 supplies DC power to the power generator 130, and the second rectifier 126 supplies a DC voltage to the battery 120. In this case, the voltage charged in the battery 120 is used as a standby voltage for supplying electrical power to the power generator in the event of a power outage.

In the event of a power outage, since the DC power output from the first rectifier 116 cuts off, only the DC power stored in the battery 120 is provided to the power generator 130.

The power integrated controller 100 according to the present invention will now be described in detail with reference to FIG. 1. A switch (SW1) interrupts AC power supplied by the AC source to the power integrated controller 100. The power protector 112 eliminates unstable factors in supplying the AC power, such as sags, noise, surges, and spikes, which are introduced from the outside through the switch SW1, and prevents noise such as electromagnetic interference (EMI) occurring in a system from being fed back into the AC source.

The power sensor 114 senses a power failure or a power recovery from the power received from the power protector 112 and reports the power failure to the integrated power operator 140. The first rectifier 116 converts the AC power input through the power protector 112 to DC power suitable for each module of the system. The second rectifier 126 converts the AC power to DC power to supply the DC power to the battery 120 as constant current and constant voltage when normal power is supplied.

The battery 120 is an environmentally friendly back-up rechargeable battery. Also, the battery 120 is constantly charged by the rectified DC power received from the second rectifier 126, and constantly sends the DC power to the booster 124. Another embodiment of the present invention is that the battery 120 includes an expansion port and thus combines with a plurality of batteries to extend the length of time for which power can be provided to a user in the event of a power failure, by an amount desired by a user.

The booster 124 boosts the DC power generated by the battery 120 to the same level as a voltage level output from the first rectifier 116 and supplies the boosted DC power to the power generator 130. The power generator 130 drops DC voltage generated by either the booster 124 or the first rectifier 116 and distributes the dropped DC level to each component in the system. Also, the power generator 130 inverts some of the DC power to AC power to output the AC power in order to supply power to a monitor and an AC load.

The power generator 130 includes the DC-to-DC converter 132 and the inverter 134. The DC-to-DC converter 132 directly drops the DC voltage received from either the first rectifier 116 or the booster 124 to DC voltages which will be supplied to each component in the system (for example, +12 V, −12 V, +5 V, −5 V, etc) and delivers the dropped DC voltages to each component of the system. The inverter 134 converts the DC power input from either first rectifier 116 or booster 124 to AC power and supplies the AC power to the system. In this case, the power generator 130 may supply any of the DC voltages dropped by the DC-to-DC converter 132 to devices such as an ADSL modem and an LCD monitor.

The integrated power operator 140 is realized with software. Upon receiving a power failure signal from the power sensor 114, the integrated power operator 140 sends information about power failure conditions and battery back-up time to each client terminal 160 through a communication network connected to the hub 150, saves work files, and generates a shut down command. On the other hand, if the power sensor 114 recognizes a power recovery, the integrated power operator 140 boots a system and then sends the power recovery message to each client terminal 160 through a communication network. Here, the battery back-up time information is detected by a voltage value output from the battery sensor 122 attached to the battery 120.

Another embodiment of the present invention is that the integrated power operator 140 automatically shuts down a computer system to reduce the consumption of energy after the computer system is idle for an amount of time set by a user, and if a wrong password is entered, the integrated power operator 140 can automatically shut down the computer system to strengthen data security.

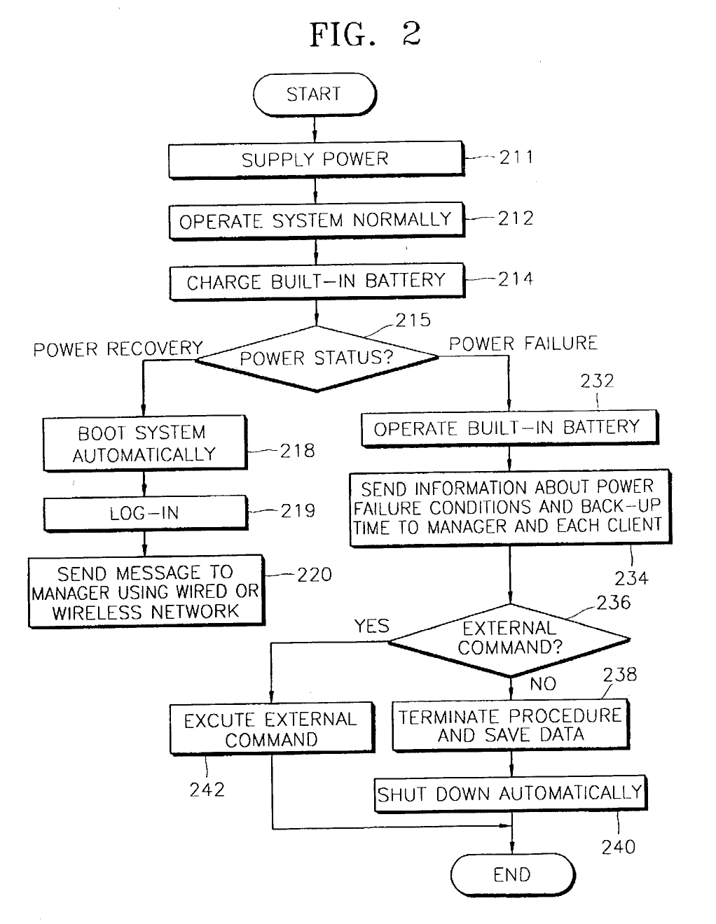

FIG. 2 is a flowchart showing a power integrated control method according to the present invention. Referring to FIG. 2, when power is supplied for a system to operate normally (steps 211 and 212), the built-in battery is charged (step 214). In this case, a power status is detected (step 215) and then if a power failure is detected, the built-in battery 120 operates (step 232) while the integrated power operator 140 sends a warning message corresponding to information about power failure conditions and battery back-up time to a system manager and the client terminal 160 through the hub 150 using a wired or wireless network (step 234). Then, if there is no external control command responsive to the warning message after a predetermined period of time lapses (step 236), the integrated power operator 140 saves work files and shuts down the procedures (step 238). If an external control command is input in response to the warning message, the integrated power operator 140 enables the system to execute the command (step 242).

On the other hand, if a power recovery signal indicating a power supply is received by the integrated power operator 140, the integrated power operator 140 automatically boots the system (step 218) and performs a log-in procedure (step 219). Then, the integrated power operator 140 sends a power recover automatic booting message to a system manager and the client terminal 160 through the hub 150 using a wired or wireless network to enable the system to operate normally (step 220).

Another embodiment of the present invention is that the power operator logs into the system through an external network, if necessary, after automatically booting the system and sending the relevant message. In this case, the integrated power operator 140 may employ a cellular phone or beeper as a means for sending a corresponding message to the system manger or the client terminal 160.

While this invention has been particularly shown and described with reference to preferred embodiments thereof, it will be understood by those skilled in the art that various changes in form and details may be made therein. That is, the power integrated power controller according to this invention is built into computer and communication systems such as hosts, servers, workstations, PC, disk arrays, redundant arrays of independent disk (RAID), hubs, asynchronous transfer mode (ATM) equipment, digital video recorders (DVRs), banking terminals, automatic teller machines, and automatic ticket issuing systems, thereby providing an integrated power control. Furthermore, a system manager is able to operate and manage the system through a network such as a web, a wide-area network (WAN) and a local-area network (LAN).

### INDUSTRIAL APPLICABILITY

As described above, the power integrated controller according to the present invention is built into a computer system and eliminates various unstable factors in a power supply to convert AC power to power which the system uses (mostly, DC). In particular, DC power that passes through the rectifier is separated to apply most of the separated DC power directly to the system and invert the remaining DC power to AC power, thus reducing the size of an inverter compared to a conventional power controller and making it easier to incorporate the inverter into the system. A built-in battery is employed to automatically shut down and boot a system in the case of a power failure while a user is away from the system, thereby achieving data protection. Furthermore, a power failure status is sent to a system manager and a user working at a remote location through a wired or wireless network to enable them to appropriately cope with the power failure.

What is claimed is:

1. A power integrated controller comprising:
a power sensor that senses the status of AC power input from the outside of the power integrated controller and generates a power supply and a power failure signal;
a first rectifier that converts the AC power received through the power sensor to DC power when a power switch is on;
a second rectifier that converts the AC power from the outside into DC power;
a battery that is charged with the DC power converted by the second rectifier in the event of normal power supply and discharges the charged DC power in the event of a power failure;
a power generator that drops the DC power generated by the first rectifier in the event of normal power supply and by the battery in the event of a power failure to DC voltage levels which are supplied to each component of a system, and inverts the DC power to AC power, and
a power operator that, upon receiving a power failure signal from the power sensor, sends information about power failure conditions and battery back-up time to a terminal through a communication network to save work data and issue a shut down command, and upon receiving a power recovery from the power sensor, boots the system and sends a booting message to the terminal through a communication network.

2. The power integrated controller of claim 1, further comprising:
a DC-to-DC converter that drops the DC voltage output from one of the first rectifier and the battery to a plurality of DC voltage levels; and
an inverter that inverts some of the DC power output from one of the first rectifier and the battery to AC power.

3. The power integrated controller of claim 1, further comprising a power protector that cuts off factors which cause voltage fluctuations introduced into the input AC power.

4. The power integrated controller of claim 1, wherein the battery includes an expansion port for connection to another rechargeable battery.

5. The power integrated controller of claim 1, further comprising a booster that boosts the DC power generated by the battery to the same level as a voltage level output from the first rectifier.

6. The power integrated controller of claim 1, further comprising a battery sensor that detects battery back-up time information from a voltage value output from the battery.

7. The power integrated controller of claim 1, wherein the system is automatically turned off after the system is idle for an amount time set by the power operator.

8. A power integrated control method comprising the steps of
upon supplying power to a system, charging a battery and operating the system normally;
operating the battery and sending information about a power failure status and battery back-up time to a system manager and a terminal through a communication network to save work data and shut down the system, upon receipt of a power failure signal; and
booting and logging into the system and sending a booting message to the terminal through a communication network upon receipt of a power recovery signal.

9. The power integrated control method of claim 8, further comprising the step of automatically saving data and shutting down a procedure unless an external command is input after sending information about the power failure status and battery back-up time, and executing the external command if the external command is input.
